(19) United States
(12) Patent Application Publication
(10) Pub. No.: US 2022/0232911 A1
(43) Pub. Date: Jul. 28, 2022

(54) NOVEL UNIVERSAL ACROSS PLATFORM ADHESIVE FACESHIELD FOR USE WITH CURRENTLY EXISTING AND OR FUTURE PERSONAL PROTECTIVE EQUIPMENT SUCH AS RESPIRATORS/FACEMASKS

(71) Applicant: Kevin-Steven Creagh Buford, New Orleans, LA (US)

(72) Inventor: Kevin-Steven Creagh Buford, New Orleans, LA (US)

(21) Appl. No.: 17/248,531

(22) Filed: Jan. 28, 2021

(51) Int. Cl. A41D 13/11; A62B 18/08

(52) U.S. Cl. CPC A41D 13/1184; A62B 18/082; A41D 13/1169

(57) ABSTRACT

The present disclosure relates to a novel universal across platform adhesive faceshield for use with respirators/facemasks that are currently existing and those that will be developed for use as personal protective equipment.

### FIELD OF INVENTION

The disclosure relates generally to Personal Protective Equipment (PPE) and specifically to a novel universal across platform adhesive faceshield for use with personal protective equipment such as but not limited to respirators/facemasks; and which does not interfere with the function of the respirator/facemask.

Prior to COVID-19 healthcare workers would typically only wear N95/KN95 respirators as disposable, single-use masks which were worn for short periods of time. Rarely did specific disease precautions require healthcare workers to simultaneously use “personal eye protective equipment” along with N95/KN95 respirators. As such, N95/KN95 respirators were not designed/engineered or manufactured with integrated personal eye protection.

This all changed during the COVID-19 pandemic where disease specific precautions require healthcare workers to continuously wear both N95/KN95 respirators and eye protection for prolonged periods of time (and especially during patient care/direct patient contact). Given that the N95/KN95 respirators were not designed or intended to have integrated eye protection, healthcare workers are currently forced to use, and very often supply, their own additional eye protection, thus lacking a true standard as exists with facemasks/respirators (i.e. KN95/N95). Options for eye protection currently available to medical professionals are not specialized or job-specific and include: plastic goggles/glasses (which tend to slip forward off of the bridge of the nose when looking down), full-face hard plastic face shields (similar to a welder's helmet) which are very heavy and place strain on the user's neck after prolonged use, non-integrated soft plastic face shields (which are prone to fogging), or the use of an additional non-respirator facemask that contains an integrated faceshield, whish is worn over their KN95/N95 respirator mask (“double-masking” which increases respiratory resistance). Reliance on previously described non-specialized personal protective eye equipment has a strong psychological, physical and emotional impact on healthcare workers, and over time results in increased stress levels, fatigue, physical discomfort and eventually suboptimal job performance.

Non-specialized faceshields can clearly affect both healthcare workers and patient outcomes alike. In that while involved in patient care, healthcare workers cannot adjust their goggles, defog their masks, or use their gloved hands to keep eye protection from slipping/falling. To do so would expose them to whatever pathogen their gear is intended to protect them from; thus resulting in the healthcare worker being potentially visually impaired, exposed to the pathogen and/or distracted with concern for their own potential exposure and/or impaired performance.

Due to the covid-19 pandemic, hundreds of millions of n95/kn95 masks have already been produced and deployed. There is a need for a cheap, effective, universal across platform adhesive faceshield which could be attached (and detached) to said hundreds of millions of N95/KN95 respirators that have already been sold/deployed. Thus eliminating most, if not all, of the aforementioned barriers encountered by healthcare workers (who currently rely upon the available supply of suboptimal personal eye protection equipment) while adding an additional standardized benefit to the existing (standardized) supply of masks and or PPE currently deployed/in production.

### BRIEF SUMMARY

The present disclosure relates to a novel universal across platform adhesive faceshield as a form of personal protective equipment for use with but not limited to respirators/facemasks and or other forms of PPE (and future PPE). In an embodiment, the novel faceshield:

(a) Attaches via an adhesive (non-limiting examples include tape, glue, Velcro, magnets, chemical/physical/magnetic adhesives) to a desired respirator/facemask
(b) May be attached to (and removed from) the desired facemask/respirator permanently, semi-permanently or temporarily and in some cases may be used on several different facemasks/respirators in sequence
(c) Provides the additional benefit of eye protection to an already existing facemask/respirator (which does not have eye protection) without interfering with the function of the respirator/facemask.
(d) Can be integrated/engineered/designed into future personal protective equipment such as but not limited to N95/KN95 mask designs; such that those masks are manufactured with an integrated embodiment of said faceshield.
e) Can be integrated/engineered/designed into future personal protective equipment such as but not limited to N95/KN95 mask designs; such that those masks are manufactured with an integrated embodiment of said faceshield; without interfering with the function of the respirator/facemask.

### SUMMARY OF THE INVENTION

In accordance with the disclosed embodiments the present disclosure relates to a novel universal across platform adhesive faceshield as a form of personal protective equipment for use with respirators/facemasks.

In an embodiment said novel universal faceshield attaches to the desired mask via an adhesive (non-limiting examples include tape, glue, Velcro, chemical/physical/magnetic adhesives).

In an embodiment said system is unique in that it is designed to attach (and detach) universally to all brands/types/shapes of respirators/facemasks which have already been produced but lack eye protection.

In an embodiment said system is unique in that it is designed to attach universally to all brands/types/shapes of respirators/facemasks currently existing and/or designed/produced in the future that lack eye protection.

In an embodiment said faceshield may also utilize additional methods of securement (non-limiting examples include ear/head loops, straps, or bands) In an embodiment said faceshield may be attached to the desired facemask/respirator permanently or temporarily and in some cases may be attached to several different facemasks/respirators at different times.

In an embodiment said novel universal platform faceshield design adds the additional benefit of eye protection to an existing desired facemask/respirator without interfering with the functionality of said respirator/facemask.

In an embodiment said faceshield can be integrated/engineered/designed into future various forms of personal protective equipment (such as N95/KN95) and mask designs, such that those masks are manufactured with said faceshield.

In an embodiment said faceshield can be integrated/engineered/designed into future personal protective equipment such as but not limited to N95/KN95 mask designs; such that those masks are manufactured with an integrated embodiment of said faceshield; without interfering with the function of the respirator/facemask.

In an embodiment said faceshield can be attached to various locations of the desired facemask/respirator per individual user preference without interfering with the functionality of either the faceshield or the facemask/respirator.

In an embodiment said faceshield contains a piece of moldable material (non-limiting examples include soft plastic/metal) which allow the faceshield to fit snugly against various desired facemasks/respirators (non-limiting examples include N95 and KN95).

In an embodiment said faceshield could be used by one user on a single mask, one user on multiple masks, or after sterilization/cleaning, many different users on many different masks/different types of masks.

In an embodiment said faceshield would render other existing types of non-specialized eye protection currently in use (goggles, face hard plastic face shields, non-integrated soft plastic face shields, and double masking) completely obsolete.

While certain features of this invention shown and described below are pointed out in the annexed claims, the invention is not intended to be limited to the details specified, since a person of ordinary skill in the relevant art will understand that various omissions, modifications, substitutions, and changes in the forms and details of the invention illustrated and in its operation may be made without departing in any way from the spirit of the present invention. No feature of the invention is critical or essential unless it is expressly stated as being “critical” or “essential.”

These and other features, aspects, and advantages of embodiments of the present disclosure will become better understood with regard to the following descriptions, claims, and accompanying drawings explained below.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements.

FIG. 1 is a schematic diagram of an embodiment of the novel universal faceshield described in the above embodiments where 100 shows a plastic (or plastic-like material), ideally non-fogging, 20 shows an adhesive band, 10 demonstrates an elastic or cloth like band designed to stabilize the faceshield on the head of the user.

FIG. 2 shows an embodiment of said novel faceshield where 100 shows a plastic (or plastic-like material), ideally non-fogging, 20 shows an adhesive band, 10 demonstrates an elastic or cloth like band designed to stabilize the faceshield on the head of the user and 30 demonstrates a modable plastic or metal portion embedded in adhesive band 20 in order to better mold to shape of facemask/respirator.

FIG. 3 is a schematic diagram of an embodiment of the novel universal faceshield described in the above embodiments where 100 shows a plastic (or plastic like material), ideally non-fogging in nature, 20 shows an adhesive band, 10 demonstrates an elastic or cloth like band designed to stabilize the faceshield on the head of the user. Which may also contain but does not require 30 which demonstrates a moldable plastic or metal portion embedded in adhesive band 20 in order to better mold to shape of facemask/respirator and the product is stabilized to the head of the user by ear-loops 50 instead of or in addition to elastic band 10

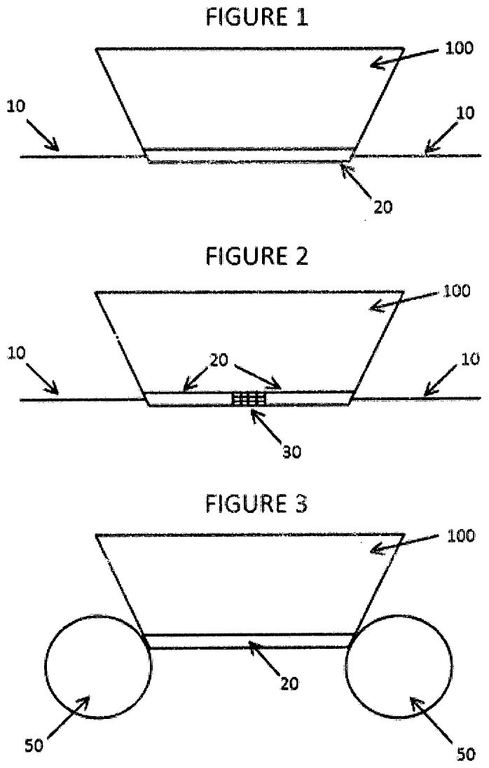

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

What is claimed is:

1. A novel universal across platform adhesive faceshield as a form of PPE for use with respirators/facemasks and other personal protective equipment that do not currently contain faceshields, regardless of brand/model/shape, and which does not interfere with the function of the respirator/facemask or personal protective equipment.
(a) Can be attached and or secured temporarily, semi-permanently or permanently to personal protective equipment such as KN95, N95 and all other facemasks/respirators that have been developed or will be developed regardless of brand/model/shape via an adhesive.
(b) Adds the benefit of eye protection to facemasks/respirators that were produced/manufactured/engineered without them.
(c) Can be attached (and detached) to various locations of the desired facemask/respirator per individual user preference without interfering with the function of either the faceshield or the facemask/respirator.

2. The faceshield in claim 1a where examples of adhesives include tape, glue, Velcro, magnets and all other forms of chemical/physical/magnetic/thermal adhesives that have been invented or will be invented.

3. The faceshield in claim 1 which can be integrated/designed/engineered to be a part of future KN95/N95 factory produced respirators.

4. The faceshield in claim 1 which can be integrated/designed/engineered to be a part of future personal protective equipment, mask designs, respirators which do not integrate faceshields.

5. The faceshield in claim 1-2 that may be used on several different facemasks/respirators in sequence by a single or multiple different users.

6. The faceshield in claims 1, 2, 4 which may also utilize additional methods of securement to the user such as: ear/head loops, straps, bands and other methods.

7. The faceshield in claims 1, 2, 4, 5 that contains a piece of moldable material such as plastic, soft metal and other materials which allows the faceshield to fit snugly against facemasks/respirators regardless of brand/model/shape.

8. The faceshield in claims 1-6 that can be used in healthcare and other industrial/construction applications.
